(19) United States
(12) Patent Application Publication
(10) Pub. No.: US 2026/0279182 A1
(43) Pub. Date: Sep. 17, 2026

(54) Patient Safety Device

(71) Applicant: Michelle Wooner, Anaheim Hills, CA (US)

(72) Inventor: Michelle Wooner, Anaheim Hills, CA (US)

(21) Appl. No.: 19/078,537

(22) Filed: Mar. 13, 2025

(51) Int. Cl. G08B 21/04; A61G 5/10; A61G 7/05; G01G 19/44

(52) U.S. Cl. CPC G08B 21/0461; A61G 7/0527; G01G 19/44; A61G 5/10; A61G 2203/10

(57) ABSTRACT

A patient safety device for alerting a caregiver that a patient with limited mobility is standing up includes a pad. A weight sensor is positioned within the pad to detect a weight of a user positioned on the pad. The weight sensor monitors the weight of the user, detecting reductions in the weight to detect when the user is moving off of the pad. A processor and a transmitter are in communication with the weight sensor wherein the processor is designed to signal the transmitter when the weight sensor detects that the user is moving off of the pad. A computer network is in wireless communication with the transmitter. The transmitter sends a notification to the computer network when the processor signals the transmitter whereby the computer network is designed to notify a caregiver that the user is moving off of the pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to safety devices and more particularly pertains to a new safety device for alerting a caregiver that a patient with limited mobility is standing up.

### (2) Description of Related Art including information disclosed under 37 CFR 1.97 and 1.98

The prior art relates to safety devices. More particularly, the prior art relates to safety devices that are used in caring for individuals who have limited mobility. For example, an individual may be elderly, bedridden, or injured, and may therefore be at risk of injury if the individual attempts to stand up from a bed or a chair without assistance. These individuals may be patients or residents in a caregiving facility, such as a hospital, a nursing home, or an elderly care center, with medical professionals acting as a caregiver. Alternatively, such individuals may live at home, with a family member or friend acting as the caregiver.

Such caregivers cannot reasonably be stationed in the immediate presence of the individual, but it can be imperative that such caregivers know when the individual is attempting to stand up without assistance, to avoid further injury. Therefore, there is a need in the art for a safety device that can alert the caregiver that the individual is attempting to stand up without assistance. Ideally, such a safety device would be positionable on the bed, chair, or other surface on which the individual is resting, and would be comfortable for the individual to sit or lay down on.

### BRIEF SUMMARY OF THE INVENTION

An embodiment of the disclosure meets the needs presented above by generally comprising a pad. A weight sensor is positioned within the pad wherein the weight sensor is designed to detect a weight of a user who is positioned on the pad. The weight sensor is designed to monitor the weight of the user and detect reductions in the weight of the user whereby the weight sensor is designed to detect when the user is moving off of the pad. A processor is in communication with the weight sensor. A transmitter is in communication with the processor wherein the processor is designed to signal the transmitter when the weight sensor detects the reduction in the weight of the user which indicates that the user is moving off of the pad. A computer network is in wireless communication with the transmitter wherein the transmitter is designed to send a notification to the computer network when the processor signals the transmitter whereby the computer network is designed to notify a caregiver that the user is moving off of the pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a patient safety device according to an embodiment of the disclosure.

FIG. 2 is a side view of an embodiment of the disclosure.

FIG. 3 is a top view of an embodiment of the disclosure.

FIG. 4 is a cross-sectional view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

FIG. 8 is a top view of an embodiment of the disclosure.

FIG. 9 is a side view of an embodiment of the disclosure.

FIG. 10 is an in-use view of an embodiment of the disclosure.

FIG. 11 is an in-use view of an embodiment of the disclosure.

FIG. 12 is a block diagram view of an embodiment of the disclosure.

### DETAILED DESCRIPTION OF THE INVENTION

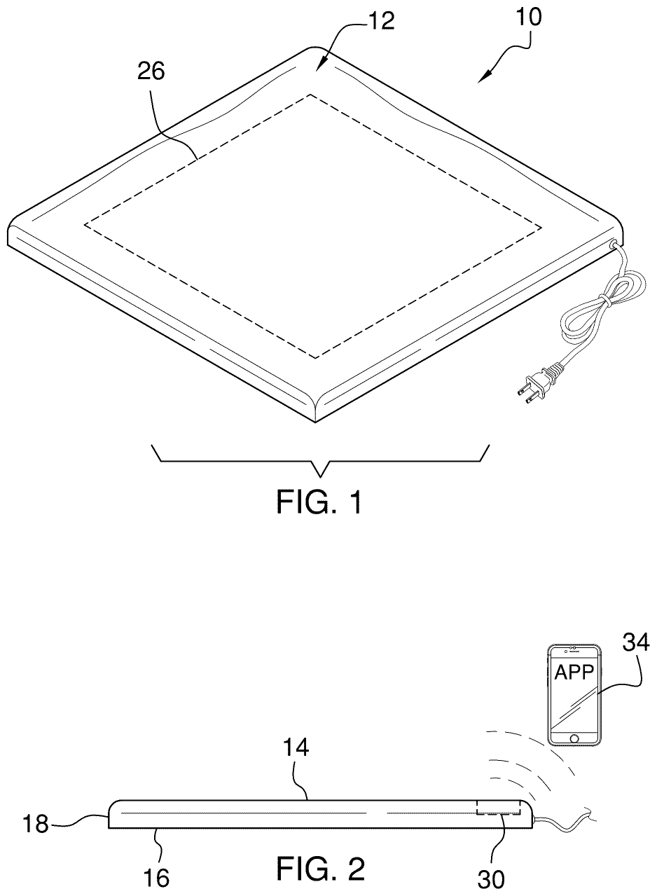

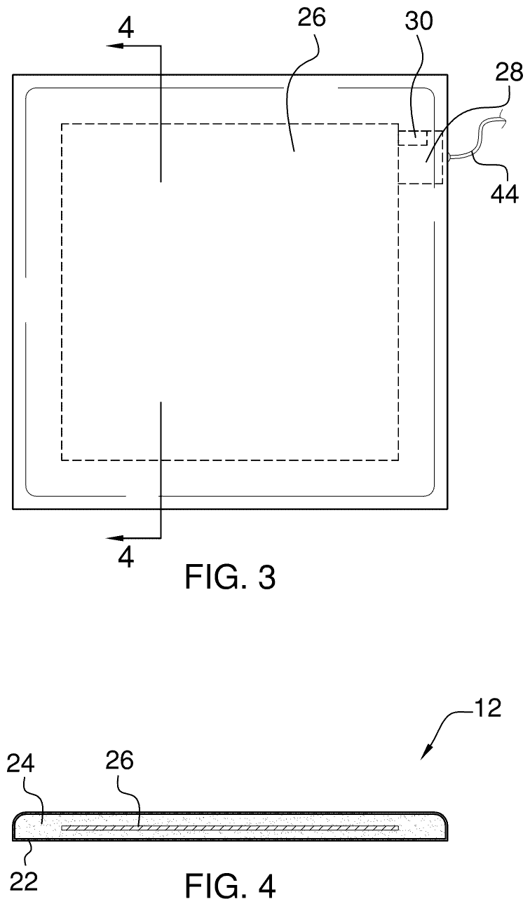

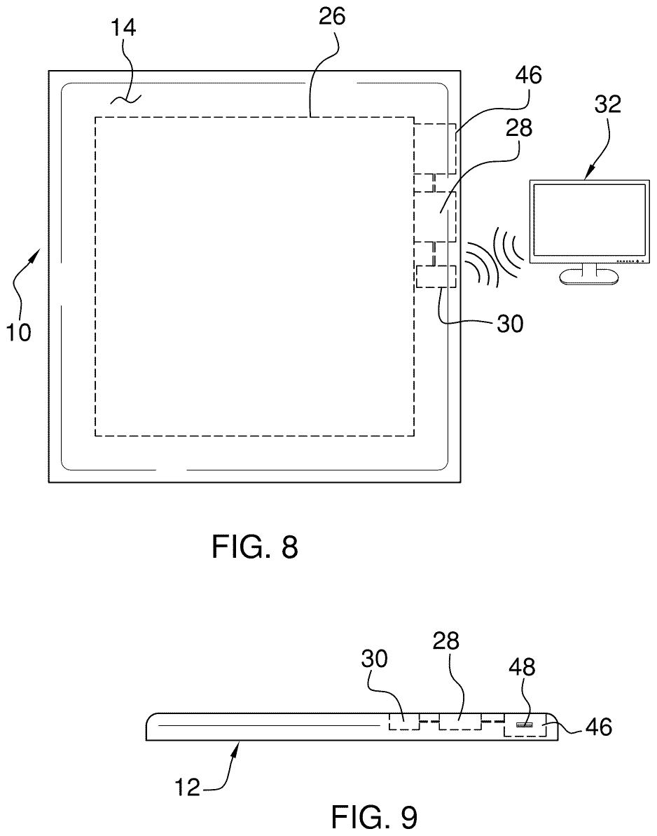

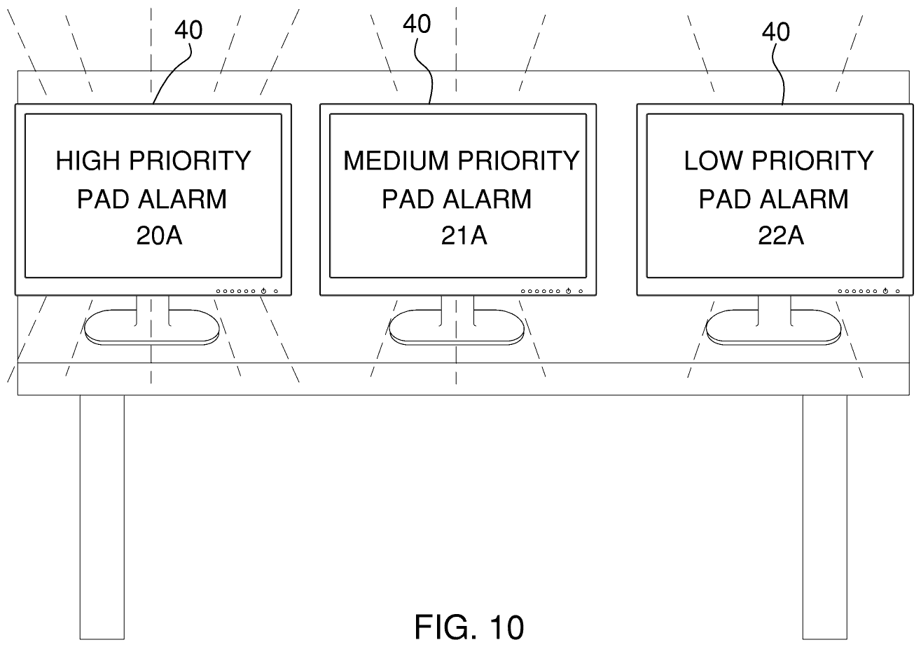

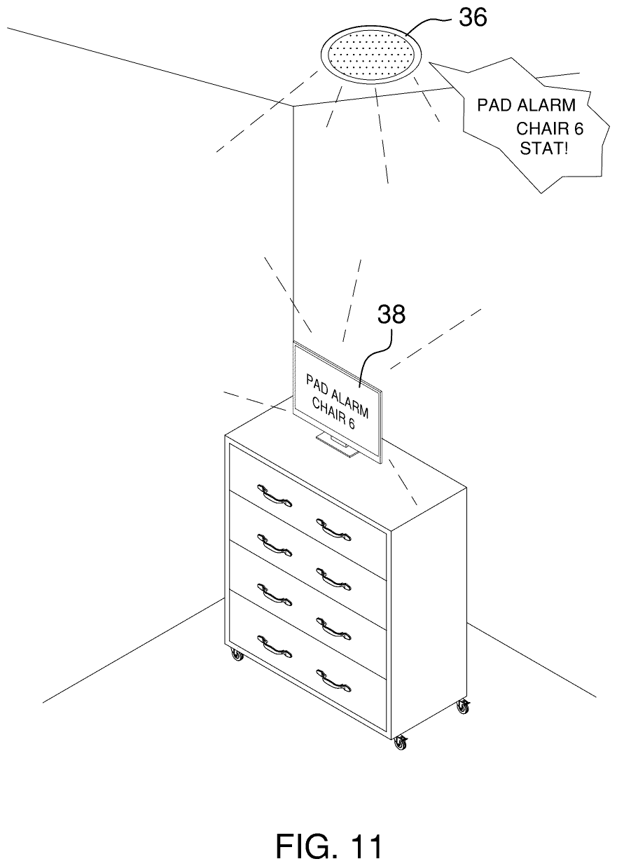

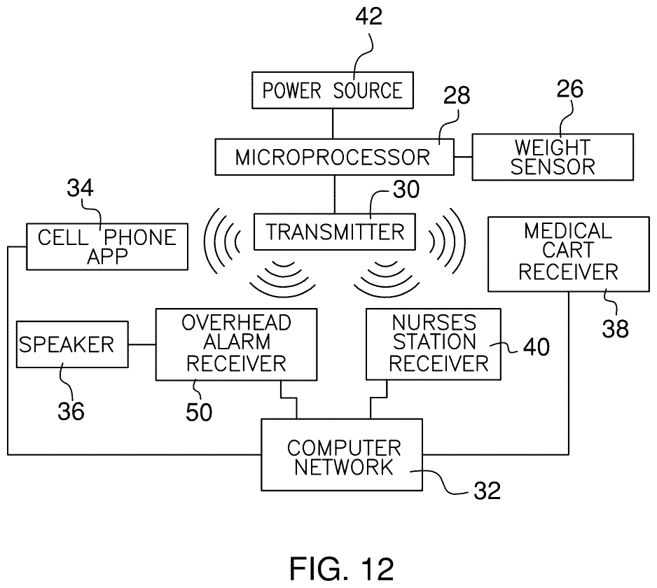

With reference now to the drawings, and in particular to FIGS. 1 through 12 thereof, a new safety device embodying the principles and concepts of an embodiment of the disclosure and generally designated by the reference numeral 10 will be described.

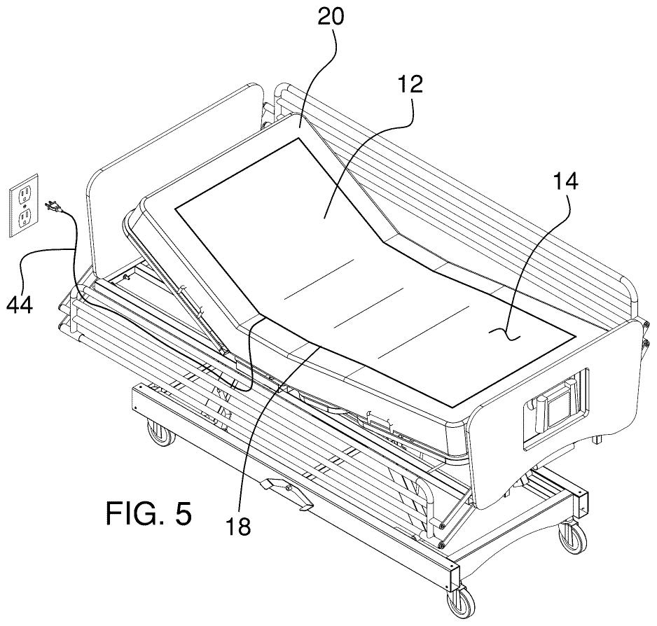

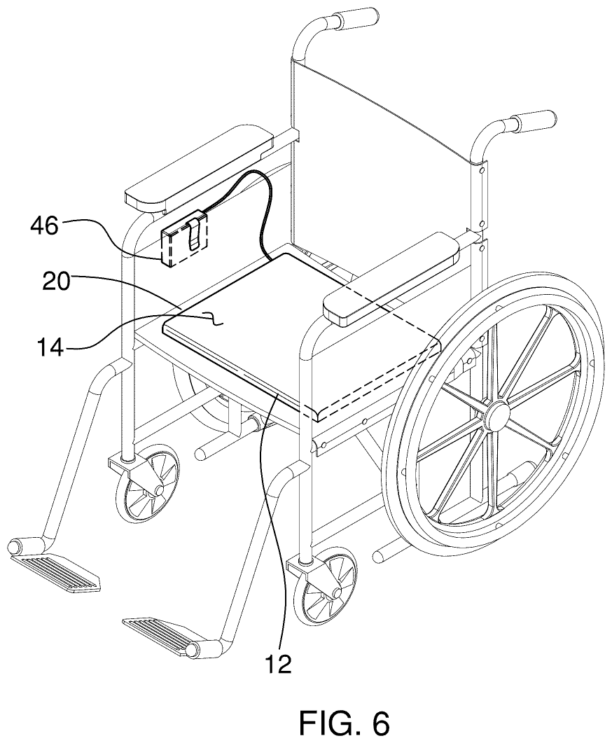

As best illustrated in FIGS. 1 through 12, the patient safety device 10 generally comprises a pad 12 that may generally include a top side 14, a bottom side 16, and a peripheral side 18 that is coupled to and extends between the top side 14 and the bottom side 16. The bottom side 16 may be planar wherein the bottom side 16 is configured to position the pad 12 flush against a surface 20 whereby the pad 12 is positionable between the surface 20 and a user. For example, the surface 20 may be a bed, as indicated by FIG. 5, or a seat of a wheelchair, as indicated by FIG. 6. The pad 12 may have a length and a width that are configured to cover substantially all of the surface 20. By covering substantially of the surface 20, most, or all, of a weight of the user can be positioned on the pad 12.

The top side 14 of the pad 12 may also be planar wherein the top side 14 is configured for being positioned between the surface 20 and the user. In other words, the top side 14 may be planar to inhibit discomfort to the user while the pad 12 is positioned between the surface 20 and the user. Comfort of the user may be particularly important when the pad 12 is used in caregiving or medical facilities, such as hospitals and nursing homes. For example, the user may be a patient who is bedridden or who has limited mobility. In such circumstances, the user may develop bedsores from sustained pressure on particular areas of the body. Bends and folds of fabric can create such sustained pressure. Therefore, top side 14 may also be planar wherein the top side 14 is configured to inhibit the pad 12 from causing bed sores or other injuries to the user.

The pad 12 may include an outer casing 22. Because the pad 12 may be used in caregiving or medical facilities and the user may have limited mobility, the outer casing 22 may be water resistant wherein the outer casing 22 is configured to inhibit penetration of water into the pad 12. For similar reasons, the outer casing 22 may also be fire resistant wherein the outer casing 22 is configured to resist ignition when the pad 12 is exposed to heat. For example, in certain preferred embodiments, the outer casing 22 may be selected from a group of materials consisting of a silicone-coated fabric, a polyester fabric, a nylon fabric, and a membrane fabric as such materials are water resistant and fire resistant. In other embodiments, the outer casing 22 may be formed of another fabric which has been chemically treated or coated to enhance the water and fire resistant properties of the fabric.

A resiliently compressible material 24 may be enclosed within the outer casing 22. The resiliently compressible material 24 is generally a soft and cushiony material which is configured to facilitate comfort of the user while the pad 12 is positioned beneath the user. For example, in certain preferred embodiments, the resiliently compressible material 24 may be selected from a group of materials consisting of cotton, linen, bamboo, hemp, polyester, rayon, viscoelastic gel, and thermoplastic elastomer gel.

A weight sensor 26 is positioned within the pad 12. The resiliently compressible material 24 may surround the weight sensor 26 wherein the resiliently compressible material 24 is configured to facilitate comfort of the user while the pad 12 is positioned beneath the user.

The weight sensor 26 is configured to detect a weight of the user who is positioned on the pad 12 while the user is resting on the surface 20. The weight sensor 26 is also configured to monitor the weight of the user and detect reductions in the weight of the user whereby the weight sensor 26 is configured to detect when the user is moving off of the pad 12 to get up from the surface 20. Accordingly, the weight sensor 26 may be programmed to determine when a threshold percentage of the weight of the user has moved off of the pad 12. Exact limits for the threshold percentage may vary, but the threshold percentage generally configured to distinguish between situations where the user is merely moving around on the surface 20 versus situations where the user is actually attempting to get up from the surface 20. Therefore, in certain preferred embodiments, the threshold percentage may be configured to be at least 25.0% of the weight of the user.

For example, the weight of the user may be 150.0 pounds. In certain embodiments, the threshold percentage may therefore equate to a reduction of at least 37.5 pounds on the pad 12. The weight sensor 26 may detect that the user weighs 150.0 pounds when the user initially sits or lays down on the surface 20. When the user merely repositions themselves on the pad 12, less than 37.5 pounds may be removed from the pad 12. Conversely, the removal of than 37.5 pounds from the pad 12 may indicate that the user is getting up from the surface 20.

The weight sensor 26 may also monitor a duration of time during which the threshold percentage of the weight of the user is removed from the pad 12. In other words, when the threshold percentage of the weight that is removed from the pad is met for only one or two seconds, the weight sensor 26 may detect that the user is merely repositioning themselves on the surface 20. Changes in the weight which last for more than a few seconds may indicate that the user is actually attempting to stand up from the surface 20. The duration of time after which the weight sensor 26 may detect that the user is moving off of the pad 12 is generally very low, for example being no more than 3.0 seconds, because the user is generally unable to safely stand up without assistance. Therefore, if the duration of time is more than approximately 3.0 seconds, the caregiver may not have time to respond and reach the user before the user is injured by falling as the user attempts to get up from the surface 20.

A processor 28 is in communication with the weight sensor 26 wherein the weight sensor 26 is configured to signal the processor 28 when the weight sensor 26 detects that the threshold percentage of the weight of the user has been removed from the pad 12. The processor 28 may be positioned within the pad 12 wherein the processor 28 is electrically coupled to the weight sensor 26. In other embodiments, the processor 28 may be in wireless communication with the weight sensor 26. The weight sensor 26 may be configured to signal the processor 28 that the user is moving off of the pad 12 when the weight sensor 26 detects that the weight of the user has been reduced by the threshold percentage.

A transmitter 30 is in communication with the processor 28 wherein the processor 28 is configured to signal the transmitter 30 when the weight sensor 26 detects that the threshold percentage of the weight of the user has been removed from the pad 12. As explained above, reductions in the weight of the user on the pad that meet the threshold percentage are generally configured to indicate that the user is moving off of the pad 12. The transmitter 30 may be positioned within the pad 12 wherein the transmitter 30 is electrically coupled to the processor 28. In other embodiments, the transmitter 30 may be in wireless communication with the processor 28.

A computer network 32 is in wireless communication with the transmitter 30. The transmitter 30 sends a notification to the computer network 32 when the processor 28 signals the transmitter 30 whereby the computer network 32 is configured to notify a caregiver that the user is moving off of the pad 12. The notification may have a plurality of priority levels whereby the notification is configured to facilitate the caregiver in determining how quickly the caregiver should respond to movement of the user off of the pad 12. Each priority level of the plurality of priority levels is generally configured to correlate with a corresponding reduction of the weight of the user on the pad 12. In other words, the plurality of priority levels may be determined based on how much of the weight of the user has moved off of the pad 12, helping the caregiver to determine how quickly the caregiver needs to respond to the user.

For example, a low priority notification may be configured to correlate with a reduction of the weight of the user that is less than 50% of the weight of the user. In such situations, the user may have merely rolled to one side of the bed or otherwise repositioned themselves such that the user is still mostly positioned on the surface 20. The low priority notification may therefore indicate that the caregiver may not need to respond immediately.

A medium priority notification may be configured to correlate with a reduction of the weight of the user that is between 50.0% and 75.0% of the weight of the user. In such situations, the user may be attempting to get up from the surface 20 but may be moving slowly or may be using other structural supports to help them move off of the surface 20 safely. The medium priority notification may therefore indicate that the caregiver should respond quickly but that the situation is not an emergency.

A high priority notification may be configured to correlate with a reduction of the weight of the user that is greater than 75.0% of the weight of the user. In such situations, the user may be moving relatively quickly to get up from the surface 20 or may already have stood up from the surface 20. The high priority notification may therefore indicate that the caregiver should respond immediately and that the situation could be an emergency.

The computer network 32 may include a personal electronic device 34, which is generally configured to be carried by the caregiver. Examples of the personal electronic device 34 include a cell phone and a tablet. The computer network 32 may also include a public address system 50, which generally has a speaker 36 that is configured to audibly emit an announcement of the notification within a building where the surface 20 on which the pad 12 is positioned is located. For example, as explained above, examples of the building may include a hospital, a nursing home, and other caregiving facilities. The public address system 50 may also be referred to as an overhead paging system, which is commonly installed in such caregiving facilities. A transitory device 38 may be configured for movement around the building. For example, the transitory device 38 may be a computer, tablet, or other device which is positioned on a medical cart that moves around the building. A stationary device 40 may be fixedly positioned within the building. For example, the stationary device 40 may be a desktop computer which is positioned at a nurse's station or in a doctor's office.

A power source 42 may be electrically coupled to the processor 28. In preferred embodiments, the power source 42 may be selected from the group consisting of a power cord 44 and a battery 46. For example, the power cord 44 may extend outwardly from the pad 12. The power cord 44 may be positioned on the peripheral side 18 of the pad 12 wherein a position of the power cord is configured to inhibit the power cord 44 from being positioned beneath the user and causing discomfort to the user while the user is positioned on the pad 12.

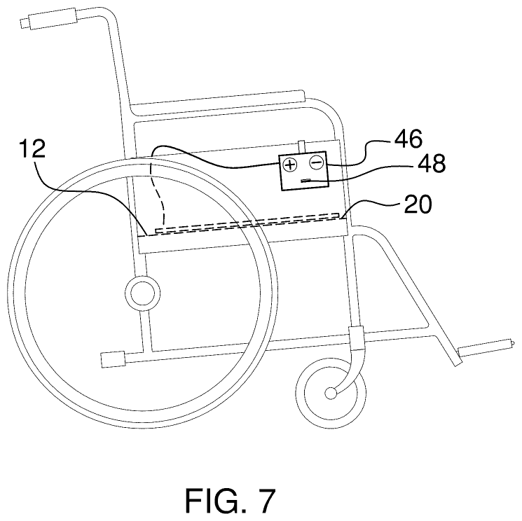

The battery 46 may be rechargeable. In some such embodiments, the battery 46 may be positioned within the pad 12 and a charging port 48 may be electrically coupled to the battery 46. The charging port 48 is generally configured to receive a charging cable for transferring power to the battery 46. The charging port 48 may be inset into the peripheral side 18 of the pad 12. The charging port 48 may be exposed within the peripheral side 18 of the pad 12. The charging port 48 is preferably positioned on the peripheral side 18 of the pad 12 to inhibit the charging port 48 from being positioned directly beneath the user and causing discomfort to the user while the user is positioned on the pad 12. In other embodiments, the battery 46 may be external to the pad 12, as indicated by FIGS. 6 and 7. The charging port 48 may be positioned directly on the battery 46 in such embodiments. For example, the charging port 48 may be inset into and exposed within a housing of the battery 46.

In use, the pad 12 can be placed on the surface 20, then the user may sit or lay down on the surface 20, over the pad 12. The resiliently compressible material 24 will facilitate comfort of the user on the surface 20, while also pad 12ding the weight sensor 26. The weight sensor 26 may determine the weight of the user, detecting the changes in the weight of the user which indicate that the user is standing up from the surface 20.

As explained above, the threshold percentage of the change in the weight of the user on the pad 12 may be determined to facilitate distinctions between when the user is merely repositioning themselves on the pad 12, and when the user is actually moving off of the surface 20. Therefore, the weight sensor 26 may be inhibited from signaling the processor 28 if the threshold percentage of the change in the weight of the user on the pad 12 is not met. In other words, when the weight of the user decreases by less than 25.0%, the weight sensor 26 may not signal the processor 28. When the weight of the user decreases by more than 25.0%, the weight sensor 26 may signal the processor 28 that the threshold percentage of the weight of the user has been removed from the pad 12.

The transmitter 30 may then send the notification to the computer network 32. In certain embodiments, the plurality of priority levels correspond to the amount of the weight of the user which has moved off of the pad 12, helping to further distinguish between situations where the user is merely repositioning themselves, or has not yet fully moved off of the surface 20, and situations where the user has completely moved off of the surface 20. The plurality of priority levels help the caregiver to evaluate how quickly the caregiver needs to respond. For example, a low priority notification may indicate to the caregiver that the user only moved partially off of the surface 20, while a high priority notification may indicate to the caregiver that the user has already stood up, fallen off of, or otherwise moved off of the pad 12 and the surface 20. The computer network 32 can send the notification to the caregiver via one or more of the personal electronic device 34, the public address system 50, the transitory device 38, and the stationary device 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A patient monitoring assembly comprising:
a pad;
a weight sensor being positioned within the pad wherein the weight sensor is configured to detect a weight of a user who is positioned on the pad, the weight sensor being configured to monitor the weight of the user and detect reductions in the weight of the user whereby the weight sensor is configured to detect when the user is moving off of the pad;
a processor being in communication with the weight sensor;
a transmitter being in communication with the processor wherein the processor is configured to signal the transmitter when the weight sensor detects the reduction in the weight of the user which indicates that the user is moving off of the pad; and
a computer network being in wireless communication with the transmitter wherein the transmitter sends a notification to the computer network when the processor signals the transmitter whereby the computer network is configured to notify a caregiver that the user is moving off of the pad.

2. The patient monitoring assembly of claim 1, the pad further comprising an outer casing and a resiliently compressible material being enclosed within the outer casing.

3. The patient monitoring assembly of claim 2, wherein the outer casing is water resistant wherein the outer casing is configured to inhibit penetration of water into the pad, the outer casing being fire resistant wherein the outer casing is configured to resist ignition when the pad is exposed to heat.

4. The patient monitoring assembly of claim 2, wherein the resiliently compressible material surrounds the weight sensor whereby the resiliently compressible material is configured to facilitate comfort of the user while the pad is positioned beneath the user.

5. The patient monitoring assembly of claim 1, wherein the weight sensor is configured to signal the processor that the user is moving off of the pad when the weight sensor detects that the weight of the user has been reduced by a threshold percentage.

6. The patient monitoring assembly of claim 5, wherein the threshold percentage is 25% whereby the weight sensor is configured to distinguish between movement of the user over the pad while the user remains on the surface and movement of the user off of the pad when the user is getting up from the surface.

7. The patient monitoring assembly of claim 1, the notification having a plurality of priority levels whereby the notification is configured to facilitate the caregiver in determining how quickly the caregiver should respond to movement of the user off of the pad.

8. The patient monitoring assembly of claim 7, wherein each priority level of the plurality of priority levels is configured to correlate with a corresponding reduction of the weight of the user on the pad.

9. The patient monitoring assembly of claim 8, the plurality of priority levels including:
a low priority notification being configured to correlate with a reduction of the weight of the user being less than 50%;
a medium priority notification being configured to correlate with a reduction of the weight of the user being between 50% and 75%; and
a high priority notification being configured to correlate with a reduction of the weight of the user being greater than 75%.

10. The patient monitoring assembly of claim 7, the computer network further comprising:
a personal electronic device being configured to be carried by the caregiver;
a public address system having a speaker being configured to audibly emit an announcement of the notification within a building where the surface on which the pad is positioned is located;
a transitory device being configured for movement around the building; and
a stationary device being fixedly positioned within the building.

11. The patient monitoring assembly of claim 1, the computer network further comprising:
a personal electronic device being configured to be carried by the caregiver;
a public address system having a speaker being configured to audibly emit an announcement of the notification within a building where the surface on which the pad is positioned is located;
a transitory device being configured for movement around the building; and
a stationary device being fixedly positioned within the building.

12. A patient monitoring assembly comprising:
a pad having a top side, a bottom side, and a peripheral side being coupled to and extending between the top side and the bottom side, the bottom side being planar wherein the bottom side is configured to position the pad flush against a surface whereby the pad is positionable between the surface and a user, the top side being planar wherein the top side is configured for being positioned between the surface and the user, the pad including:
an outer casing being water resistant wherein the outer casing is configured to inhibit penetration of water into the pad, the outer casing being fire resistant wherein the outer casing is configured to resist ignition when the pad is exposed to heat, the outer casing being selected from a group of materials consisting of a silicone-coated fabric, a polyester fabric, a nylon fabric, and a membrane fabric; and
a resiliently compressible material being enclosed within the outer casing, the resiliently compressible material being selected from a group of materials consisting of cotton, linen, bamboo, hemp, polyester, rayon, viscoelastic gel, and thermoplastic elastomer gel;
a weight sensor being positioned within the pad wherein the weight sensor is configured to detect a weight of the user who is positioned on the pad while the user is resting on the surface, the weight sensor being configured to monitor the weight of the user and detect reductions in the weight of the user, the weight sensor being programmed to determine when the weight of the user has been reduced by a threshold percentage of the weight of the user whereby the weight sensor is configured to detect when the user is moving off of the pad to get up from the surface, the threshold percentage configured for being at least 25% of the weight of the user whereby the weight sensor is configured to distinguish between movement of the user over the pad while the user remains on the surface and movement of the user off of the pad when the user is getting up from the surface, the resiliently compressible material surrounding the weight sensor wherein the resiliently compressible material is configured to facilitate comfort of the user while the pad is positioned beneath the user;
a processor being in communication with the weight sensor wherein the weight sensor is configured to signal the processor when the weight sensor detects that the threshold percentage of the weight of the user has been removed from the pad, the processor being positioned within the pad wherein the processor is electrically coupled to the weight sensor, the weight sensor being configured to signal the processor that the user is moving off of the pad when the weight sensor detects that the weight of the user has been reduced by the threshold percentage;
a transmitter being in communication with the processor wherein the processor is configured to signal the transmitter when the weight sensor detects that the threshold percentage of the weight of the user has been removed from the pad, the transmitter being positioned within the pad wherein the transmitter is electrically coupled to the processor;
a computer network being in wireless communication with the transmitter wherein the transmitter sends a notification to the computer network when the processor signals the transmitter whereby the computer network is configured to notify a caregiver that the user is moving off of the pad, the notification having a plurality of priority levels, each priority level of the plurality of priority levels being configured to correlate with a corresponding reduction of the weight of the user on the pad, the plurality of priority levels including:
a low priority notification being configured to correlate with a reduction of the weight of the user being less than 50%;
a medium priority notification being configured to correlate with a reduction of the weight of the user being between 50% and 75%; and
a high priority notification being configured to correlate with a reduction of the weight of the user being greater than 75%;
the computer network including:
a personal electronic device being configured to be carried by the caregiver;
a public address system having a speaker being configured to audibly emit an announcement of the notification within a building where the surface on which the pad is positioned is located;
a transitory device being configured for movement around the building; and
a stationary device being fixedly positioned within the building; and
a power source being electrically coupled to the processor, the power source being selected from the group consisting of:
a power cord extending outwardly from the pad, the power cord being positioned on the peripheral side of the pad; and
a battery, the battery being rechargeable.
